(19) United States
(12) Patent Application Publication
(10) Pub. No.: US 2012/0171459 A1
(43) Pub. Date: Jul. 5, 2012

(54) JOINT TAPE AND ABRASIVE ARTICLES PREPARED WITH SAME

(75) Inventor: Charles G. Herbert, Shrewsbury, MA (US)

(73) Assignees: SAINT-GOBAIN ABRASIFS, Conflans-Sainte-Honorine (FR); SAINT-GOBAIN ABRASIVES, INC., Worcester, MA (US)

(21) Appl. No.: 13/341,887

(22) Filed: Dec. 30, 2011

Related U.S. Application Data
(60) Provisional application No. 61/428,781, filed on Dec. 30, 2010.

(51) Int. Cl. B32B 5/02; B05D 1/36; C09J 7/02; B32B 27/12; B32B 27/08

(52) U.S. Cl. 428/297.7; 428/423.1; 428/423.5; 428/423.7; 428/424.8; 428/354; 427/203

(57) ABSTRACT

A joint tape includes a film substrate, fibers disposed on a major surface of the film substrate, and a binder or adhesive disposed over the major surface of the film substrate. The binder or adhesive includes a latent cure urethane formulation including a surface deactivated isocyanate cross-linking agent and a polyol component.

### CROSS-REFERENCE TO RELATED APPLICATION(S)

The present application claims priority from U.S. Provisional Patent Application No. 61/428,781, filed Dec. 30, 2010, entitled “JOINT TAPE AND ABRASIVE ARTICLES PREPARED WITH SAME,” naming inventor Charles G. Herbert, which application is incorporated by reference herein in its entirety.

### FIELD OF THE DISCLOSURE

This disclosure, in general, relates to joint tapes, abrasive articles prepared with such joint tapes, and methods of making and using such joint tapes.

### BACKGROUND

Abrasive belts and circles are used in a variety of industries. For example, belts can be used in belt sanders, such as to abrade wood or metal or to remove paint from various objects. In another example, a circular abrasive can be applied on a rotatable shaft to facilitate edging and finishing of articles.

To form such loop abrasives, the coated abrasive is wrapped so that the abrasive side of the abrasive forms an outer surface and the non-abrasive side forms an inside surface of the belt. Conventionally, the ends of the coated abrasive are joined together at a joint and are secured together at the joint with a tape and optionally, additional adhesive. Such a tape and adhesive can provide desirable mechanical properties, such as strength, and can provide resilience, resisting continuous flexing as the circle or belt rotates around guides and is subject to tension as it is being used.

Conventional tapes include an adhesive layer formed of a polyurethane. Such conventional polyurethane adhesives are difficult to handle and are sensitive to environmental conditions. For example, conventional polyurethane binders or adhesives are solvent based adhesives that are stored at low temperatures, such as below minus 20° C. to prevent premature curing. Further, such conventional polyurethane binders or adhesives are sensitive to environmental conditions such as humidity. As such, such conventional joint tapes including such conventional polyurethane adhesives are expensive to utilize and process and can underperform if exposed to excess humidity.

As such, an improved joint tape would be desirable.

### BRIEF DESCRIPTION OF THE DRAWINGS

The present disclosure may be better understood, and its numerous features and advantages made apparent to those skilled in the art by referencing the accompanying drawings.

FIG. 1 and FIG. 2 include illustrations of an exemplary joint tape.

FIG. 3 includes an illustration of an exemplary abrasive belt.

FIG. 4 includes an illustration of an exemplary joint.

The use of the same reference symbols in different drawings indicates similar or identical items.

### DETAILED DESCRIPTION

In an example, a joint tape includes a substrate and fibrous material bonded to the substrate with a binder and includes an adhesive disposed over the fibrous material. In particular, the substrate can be a film, such as a polyester film. The fibrous material can be fiber strands applied to a major surface of the substrate and secured to the substrate with a binder. In an example, the binder can be a latent cure polyurethane formulation. An exemplary latent cure polyurethane formulation includes a surface deactivated isocyanate cross-linker and a polyol component. The polyol component can be modified to include urethane functionality. In another example, the adhesive can be a latent cure polyurethane formulation. Alternatively, the adhesive can be a solvent-borne polyurethane formulation.

In a further exemplary embodiment, a method of forming a tape includes applying a binder to a substrate film, applying the fibrous material over the binder, and curing the binder. In particular, the binder can be a latent cure polyurethane binder. In addition, the method can include applying an adhesive over the fibrous material. For example, the adhesive can be a latent cure polyurethane adhesive. In an alternative example, the adhesive can be a solvent-borne polyurethane adhesive.

In another exemplary embodiment, a method of forming a loop abrasive article includes forming joint ends on a coated abrasive article, applying an adhesive to the joint ends, and applying a tape over the adhesive. The tape includes a binder or adhesive that is formed of a latent cure polyurethane binder or adhesive.

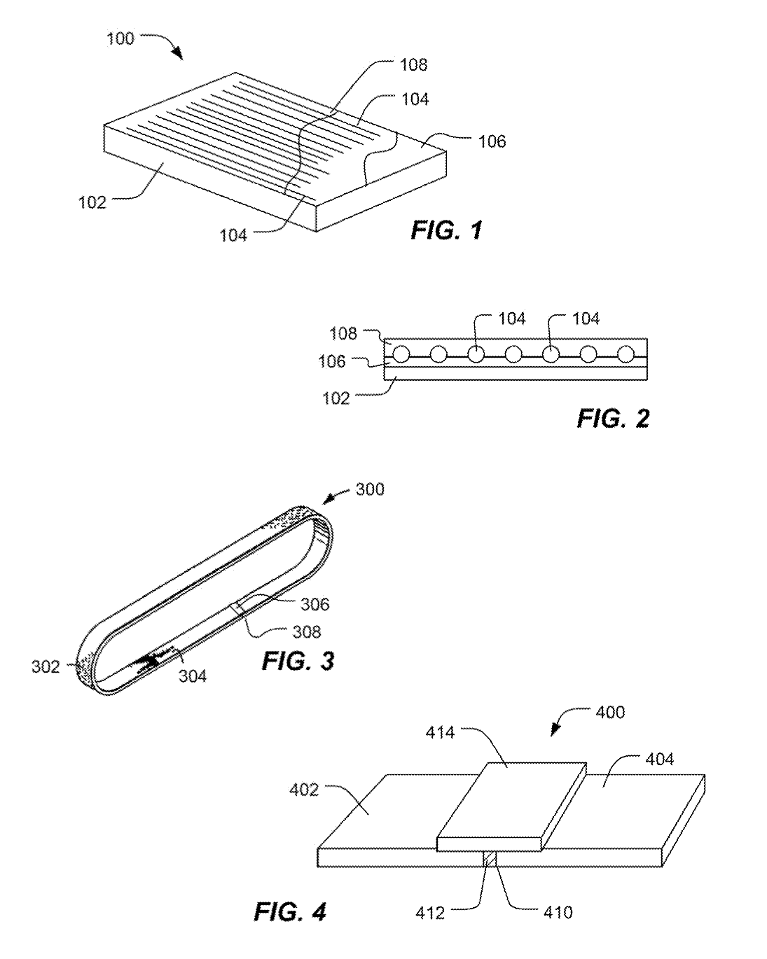

In a particular example, FIG. 1 and FIG. 2 include illustrations of an exemplary joint tape. The joint tape 100 includes a substrate 102 and fibrous material 104 applied over a major surface of the substrate 102. The fibrous material can be secured to the substrate using a binder 106. In addition, an adhesive 108 can be applied over the fibrous material 104 and binder 106. In an example, the fibrous material 104 includes fibers applied in parallel to each other. In particular, the fibers can be parallel to a machine direction of the abrasive article to which the joint tape 100 is to be applied.

The binder 106 can include a latent cure polyurethane formulation. The adhesive 108 can include a latent cure polyurethane formulation or can include a solvent-borne polyurethane formulation.

In an example, the substrate 102 includes a polymeric film (including primed films), such as a polyolefin film (e.g., polyethylene or polypropylene, including biaxially oriented polypropylene), a polyester film (e.g., polyethylene terephthalate or a liquid crystal polymer), a polyamide film, a cellulose ester film, or any combination thereof; a metal foil; a mesh; a foam (e.g., natural sponge material or polyurethane foam); a cloth (e.g., cloth made from fibers or yarns comprising polyester, nylon, silk, cotton, poly-cotton or rayon); a paper; a nonwoven material; or any combination thereof. A cloth substrate can be woven or stitch bonded. In particular examples, the substrate is selected from a group consisting of paper, polymer film, or a combination thereof. In particular, the substrate 102 can be a polymer film such as a polyester film, a polyamide film, a polyaramid film, a polyimide film, a polyolefin, or any combination thereof. For example, the substrate 102 can include a polyethylene terephthalate (PET) film.

In a further example, the fibrous material 104 can be formed of strands, which can be formed of inorganic material, such as a fiberglass. In another example, the strands of the fibrous material 104 can be formed of polymeric fibers, such as fibers of polyester, polyether, polyolefin, polybenzimidazole (PBI), or any combination thereof. An exemplary polyolefin includes a polyolefin homopolymer, such as polyethylene, polypropylene, polybutene, polypentene, or polymethylpentene; a polyolefin copolymer, such as ethylene-propylene copolymer, ethylene-butene copolymer, or ethylene-octene copolymer; or any blend or combination thereof. In a further example, a polyester includes polyethylene terephthalate (PET) or copolymers thereof. In another example, the polyester is a liquid crystal polymer. An exemplary liquid crystal polymer includes aromatic polyester polymers, such as those available under tradenames XYDAR® (Amoco), VECTRA® (Hoechst Celanese), SUMIKOSUPER™ (Sumitomo Chemical), EKONOL™ (Saint-Gobain), DuPont HX™ or DuPont ZENITE™ (E.I. DuPont de Nemours), RODRUN™ (Unitika), GRANLAR™ (Grandmont), or any combination thereof.

The binder 106 is formed of a latent cure polyurethane formulation, such as a water-borne latent cure polyurethane formulation. In a particular example, the binder 106 is formed from an aqueous solution including a pre-polymer and a surface deactivated solid isocyanate cross-linking agent. In an example, the surface deactivated solid isocyanate cross-linking agent includes a multifunctional isocyanate component shielded from other components by an inert coating, such as a urea coating. In addition, the binder formulation can include a pre-polymer, such as a polyol component. The pre-polymer can include terminal groups reactive with the isocyanate cross-linking agent, such as urethane or urea terminal groups. For example, the polyol can include a polyether polyol including urethane or urea terminal groups.

The isocyanate component can include multifunctional isocyanate components, such as di-isocyanate, tri-isocyanate, or higher functional isocyanate components. In particular, the isocyanate component has an isocyanate functionality (i.e., number of available reactive isocyanate groups) of at least 2, such as at least 3 or even at least 4. An exemplary diisocyanate monomer can include toluene diisocyanate, m-phenylene diisocyanate, p-phenylene diisocyanate, xylene diisocyanate, 4,4′-diphenylmethane diisocyanate, hexamethylene diisocyanate, isophorone diisocyanate, polymethylene polyphenyl diisocyanate, 3,3′-dimethyl-4,4′-biphenylene diisocyanate, 3,3′-dimethyl-4,4′-diphenylmethane diisocyanate, 3,3′-dichloro-4,4′-biphenylene diisocyanate, or 1,5-naphthalene diisocyanate; their modified products, for instance, carbodiimide-modified products; or the like; or any combination thereof. Such diisocyanate monomers can be used alone or in admixture of at least two kinds. In a particular example, the isocyanate component can include methylene diphenyl diisocyanate (MDI), toluene diisocyanate (TDI), hexamethylene diisocyanate (HDI), isophorone diisocyanate (IPDI), or any combination thereof. In an example, the isocyanate can include methylene diphenyl diisocyanate (MDI) or toluene diisocyanate (TDI). In particular, the isocyanate includes methylene diphenyl diisocyanate (MDI) or derivatives thereof. In another example, the isocyanate includes toluene diisocyanate (TDI) or derivatives thereof. An exemplary multifunctional isocyanate component includes triphenyl methane triisocyanate, tris(isocyanatophenyl) thiophosphate, polymethylene polyphenyl polyisocyanates, or any combination thereof. For example, the isocyanate can be a TDI dimer, available under the name Disperscoll XP 2514 from Bayer. In another example, the isocyanate component is an IPDI trimer, available as Desmondur ZXP 2589.

In particular, the multifunctional isocyanate forms small crystalline structures that can be formulated to include a deactivated surface, such as a surface having urea functionality. For example, the deactivated surface can include a urea surface coating. The surface deactivated multifunctional isocyanate forms a crystalline cross-linker that can be dispersed within an aqueous system without causing a reaction of the isocyanate within the aqueous solution. In addition, the solution can include pre-polymers. Exemplary pre-polymers can include pre-polymers having urea or urethane functionality and polymer blocks, such as polyol blocks. Exemplary polyol blocks can include polyether polyol blocks, polyester polyol blocks, polyether-ester polyol blocks, or any combination thereof. Such polymer blocks can be terminated with urea or urethane groups.

In an example, the polyol can be a polyether polyol, a polyester polyol, modified or grafted derivatives thereof, or any combination thereof. A suitable polyether polyol can be produced by polyinsertion via double metal cyanide catalysis of alkylene oxides, by anionic polymerization of alkylene oxides in the presence of alkali hydroxides or alkali alcoholates as catalysts and with the addition of at least one initiator molecule containing 2 to 6, preferably 2 to 4, reactive hydrogen atoms in bonded form, or by cationic polymerization of alkylene oxides in the presence of Lewis acids, such as antimony pentachloride or boron fluoride etherate. A suitable alkylene oxide can contain 2 to 4 carbon atoms in the alkylene radical. An example includes tetrahydrofuran; 1,2-propylene oxide; 1,2- or 2,3-butylene oxide; ethylene oxide; 1,2-propylene oxide; or any combination thereof. The alkylene oxides can be used individually, in succession, or as a mixture. In particular, mixtures of 1,2-propylene oxide and ethylene oxide can be used, whereby the ethylene oxide is used in quantities of 10% to 50% as an ethylene oxide terminal block so that the resulting polyols display over 70% primary OH terminal groups. An example of an initiator molecule includes water or dihydric or trihydric alcohols, such as ethylene glycol, 1,2-propanediol and 1,3-propanediol, diethylene glycol, dipropylene glycol, ethane-1,4-diol, glycerol, trimethylol propane, or any combination thereof.

Suitable polyether polyols, such as polyoxypropylene polyoxyethylene polyols, have average functionalities of 1.5 to 4, such as 2 to 3, and number-average molecular weights of 800 g/mol to 25,000 g/mol, such as 800 g/mol to 14,000 g/mol, particularly 2,000 g/mol to 9,000 g/mol.

In another example, the polyol can include a polyester polyol. In an example, a polyester polyol is derived from dibasic acids such as adipic, glutaric, fumaric, succinic or maleic acid, or anhydrides and di-functional alcohols, such as ethylene glycol, diethylene glycol, propylene glycol, di or tripropylene glycol, 1-4 butane diol, 1-6 hexane diol, or any combination thereof. For example, the polyester polyol can be formed by the condensation reaction of the glycol and the acid with the continuous removal of the water by-product. A small amount of high functional alcohol, such as glycerin, trimethanol propane, pentaerythritol, sucrose or sorbitol or polysaccarides can be used to increase branching of the polyester polyol. The esters of simple alcohol and the acid can be used via an ester interchange reaction where the simple alcohols are removed continuously like the water and replaced by one or more of the glycols above. Additionally, polyester polyols can be produced from aromatic acids, such as terephthalic acid, phthalic acid, 1,3,5-benzoic acid, their anhydrides, such as phthalic anhydride. In a particular example, the polyol can include an alkyl diol alkyl ester. For example, the alkyl diol alkyl ester can include trimethyl pentanediol isobutyrate, such as 2,2,4-trimethyl-1,3-pentanediol isobutyrate.

In a particular example, the polyol can be a multifunctional polyol having at least two primary hydroxyl groups. For example, the polyol can have at least three primary hydroxyl groups. In a particular example, the polyol is a polyether polyol having an OH number in the range of 5 mg KOH/g to 70 mg KOH/g, such as a range of 10 mg KOH/g to 70 mg KOH/g, a range of 10 mg KOH/g to 50 mg KOH/g, or even 15 mg KOH/g to 40 mg KOH/g. In a further example, the polyether polyol can be grafted. For example, the polyol can be a polyether polyol grafted with styrene-acrylonitrile. In a further example, the polyol can include a blend of multifunctional, such as trifunctional polyether polyols, and polyols that are grafted, such as a polyether polyol having a grafted styrene-acrylonitrile moiety. In particular, the polyol is a polyether polyol, available under the trade name Lupranol® available from Elastogran by BASF Group.

In addition, the binder formulation can include a catalyst. The catalyst can include an organometallic catalyst, an amine catalyst, or a combination thereof. An organometallic catalyst, for example, can include dibutyltin dilaurate, a lithium carboxylate, tetrabutyl titanate, a bismuth carboxylate, or any combination thereof. The amine catalyst can include a tertiary amine, such as tributylamine, N-methyl morpholine, N-ethyl morpholine, N,N,N′,N′-tetramethyl ethylene diamine, pentamethyl diethylene triamine and higher homologues, 1,4-diazabicyclo-[2,2,2]-octane, N-methyl-N′-dimethylaminoethyl piperazine, bis(dimethylaminoalkyl)piperazine, N,N-dimethyl benzylamine, N,N-dimethyl cyclohexylamine, N,N-diethyl benzylamine, bis(N,N-diethylaminoethyl) adipate, N,N,N′,N′-tetramethyl-1,3-butane diamine, N,N-dimethyl-β-phenyl ethylamine, bis(dimethylaminopropyl)urea, bis(dimethylaminopropyl)amine, 1,2-dimethyl imidazole, 2-methyl imidazole, monocyclic and bicyclic amidine, bis(dialkylamino) alkyl ether, such as e.g., bis(dimethylaminoethyl)ethers, tertiary amines having amide groups (such as formamide groups), or any combination thereof. Another example of a catalyst component includes Mannich bases including secondary amines, such as dimethylamine, or aldehyde, such as formaldehyde, or ketone such as acetone, methyl ethyl ketone or cyclohexanone or phenol, such as phenol, nonyl phenol or bisphenol. A catalyst in the form of a tertiary amine having hydrogen atoms that are active with respect to isocyanate groups can include triethanolamine, triisopropanolamine, N-methyldiethanolamine, N-ethyl diethanolamine, N,N-dimethyl ethanolamine, reaction products thereof with alkylene oxides such as propylene oxide or ethylene oxide, or secondary-tertiary amines, or any combination thereof. Silamines with carbon-silicon bonds can also be used as catalysts, for example, 2,2,4-trimethyl-2-silamorpholine, 1,3-diethyl aminomethyl tetramethyl disiloxane, or any combination thereof.

When coated on a substrate, the water-borne latent cure adhesive can be dried, leaving the polyurethane particles and the surface deactivated multifunctional isocyanate. Upon heating, the deactivated surface loses integrity and the multifunctional isocyanate melts and flows to contact the polyurethane particles which can also melt and flow. A reaction takes place between the multifunctional isocyanate cross-linker and the urea, alcohol, or amine terminated pre-polymer to form a polyurethane binder or adhesive.

In a particular example, the latent cure polyurethane formulation can be a PermAttach 395HC or Dorus ND4100, available from Henkel.

Returning to FIG. 1, an adhesive 108 is applied over the fibrous material 104 relative to the substrate 102, the binder 106 and the fibrous material 104. In an example, the adhesive 108 includes a solvent-borne polyurethane formulation. For example, the polyurethane formulation can include a single component polyurethane formulation that reacts when in contact with moisture. In another example, the solvent-borne polyurethane formulation can be a two component polyurethane formulation. In particular, the solvent-borne polyurethane precursor can include isocyanate terminated block polymers. Alternatively, the adhesive 108 can be a water-borne latent cure polyurethane formulation as described above. For example, the latent cure polyurethane formulation can be formed as described above to include a polyol component and a surface deactivated isocyanate component.

Such joint tape is particular useful in forming loop abrasive articles, such as belt abrasive articles or circular abrasive articles. Turning to FIG. 3, an exemplary belt abrasive article 300 is illustrated. In an example, FIG. 3 includes an illustration of a belt abrasive article 300 including an abrasive outer layer 302 and an inner layer 304. At joint 308, a tape 306 is applied to secure the joint formed between the two ends of the coated abrasive. Alternatively, an adhesive can be used to secure the ends of the coated abrasive.

FIG. 4 includes an illustration 400 of an exemplary joint. For example, FIG. 4 includes an illustration of coated abrasive article 400 including ends 402 and 404 forming outer surfaces 406 and 408 that include an abrasive bound to the surface of the substrate 402 or 404. At a joint 410 defined between the end 402 and 404, an adhesive 412 can optionally be applied. In a further example, a joint tape 414, such as the joint tape described above in relation to FIG. 1 and FIG. 2, can be applied over the joint 410 to provide the joint 410 with additional flexibility and viability. Alternatively, the ends 402 and 404 can be secured to form the joint 410 with an adhesive, free of the joint tape 414.

At the joint 410, the coated abrasive ends 402 and 404 can be prepared to receive a joint tape, such as by skiving, sand blasting, grinding, splicing, or cutting the ends to form a desirable contact surface between the ends 402 and 404 of the coated abrasive article 400. Further, the edge of each of the ends 402 or 404 forming the joint 410 can be patterned to provide additional surface area for forming the joint. In another example, the edge can be skived or ground at an angle forming an overlap joint.

Following skiving or other joint preparation techniques, an adhesive 412 can optionally be applied to secure the joint 410. In an example, the adhesive 412 can be a solvent-borne polyurethane adhesive. Alternatively, the adhesive 412 applied to the joint 410 can be a latent cure adhesive, such as a water-borne latent cure formulation. In particular, the latent cure adhesive includes the crystalline multifunctional isocyanate cross-linker surrounded by deactivated surface and includes a polyol component, such a polyurethane particles suspended in the solution.

The joint tape 414 can be applied over the joint 410. In particular, the joint tape 414 includes a film substrate having fibers bound to a major surface of the film substrate by a latent cure polyurethane formulation. The joint tape 414 further includes an adhesive. The adhesive can be a solvent-borne polyurethane adhesive or can include a latent cure polyurethane formulation as described above.

The tape 414 can be applied over the adhesive 412 and heated to secure the tape to the terminal ends 402 and 404 of the coated abrasive. The tape can be applied over the joint 410 with pressure in a range of 1000 to 4000 psi. In particular, the tape 414 or joint 410 can be heated to a temperature of at least 100° F., such as at least 120° F., or even 150° F. In particular, the tape 414 or joint 410 can be heated to a temperature of at least 180° F., such as at least 200° F., at least 212° F., or even at least 220° F.

The adhesive tape exhibits desirable properties. For example, the adhesive tape can exhibit a desirable Triple Head Flex of at least 40. In an example, the Triple Head Flex can be at least 50, such as at least 55, or even at least 60.

In a particular example, the fibers are bound to the substrate in a desirable strength when the latent cure polyurethane is utilized. When tested using an Instron 3366 tester using a 20 lb load cell at 50.8 mm/min, single fibers secured to the backing using the latent cure polyurethane formulation after curing, provide a desirable peel strength, when peeling the fiber from the substrate. For example, the average peel strength can be at least 4 N, such as at least 4.5 N, at least 4.8 N, or even at least 5.0 N. In another test, the peel strength is at least 0.5 N/mm, such as at least 0.6 N/mm, after curing. Following a post cure treatment as described below in Example 2, the peel strength can be at least 1 N/mm, such as at least 1.25 N/mm, or even at least 1.5 N/mm.

A ratio between the pre-cure treated and cure peel strength in the binder system, is at least 1.1. For example, the ratio, referred to herein as the post-cure treated peel strength index can be at least 1.2, such as at least 1.6, or even at least 1.8.

When used as a joint tape, particularly when the adhesive is a latent cure polyurethane formulation, the tape can exhibit desirable peak break strength. For example, samples can be tested on an Instron 4469 tester at a cross head speed of 2″ per minute with a 1000 lb. load cell. In particular, the peak break strength can be at last 120 lbs, such as at least 130 lbs, at least 135 lbs, or even at least 140 lbs.

### EXAMPLES

### Example 1

A latent cure polyurethane formulation is used to binder fibers to a film substrate. The peel strength of the samples and comparative samples are tested.

Solvent borne fiber reinforcement laminating adhesive Control Sample:A 10:1 mixture of Adcote 122 (Rohm and Haas) laminating adhesive and Coreactant 9L10 (Rohm and Haas) is diluted in a 3:1 toluene:methyl ethyl ketone solution to 36% solids. The coating is applied to a 5 mil thick untreated Mylar film at 6 mil wet. A release coating treated Mylar film with 12 inch fibers attached to the face and spaced 1″ apart is applied onto the wet adhesive surface. A 5 lb rolling weight is used to press the fibers into the adhesive before oven drying at 225° F. for 3 minutes.

Waterborne fiber reinforcement laminating adhesive (Sample 1): A 6 mil wet film of Dorus ND4100 latent cure adhesive (Henkel) is applied to a 5 mil untreated Mylar film. Peel test samples are prepared in the same manner as described in relation to the Control Sample.

For testing, the release layer of Mylar is removed and the individual fibers are submitted to peel testing via an Instron 3366. A 20 lb load cell is used at 50.8 mm/min crosshead speed. The samples are gripped with pneumatic clamps attached to a single fiber end and the film backing. The average peel strength in Newtons is measured over a 180 mm peel. Table 1 illustrates the average peel strength.

TABLE 1
Average Peel Strength of the Samples

| | Avg. Peel |
|---|---|
| | Strength (N) |
| Control | 3.53 |
| Sample 1 | 5.02 |

### Example 2

To a treated Mylar backing, Dorus ND4100 is applied at 0.8 oz/yd² using an oven temperature of 200° F. and a line speed of 10 yd/min (Sample 2). Prior to drying, a beam of 640 denier polyester fiber is nipped onto the laminating adhesive using a nip pressure of 150 psi and a nip temperature of 250° F. The resulting fiber laminated roll is stored 1 week in a hot room at 150° F. before peel testing is performed. The process is repeated using a coat weight of 1 oz/yd² (Sample 3). A control example is prepared using the same conditions and applying 1 oz/yd² of a solvent-borne laminating adhesive of the same composition as described in the control sample of Example 1.

Using the industrially laminated fiber samples, 12″ wide by 8″ long (in fiber direction) pieces are cut from the rolls. The first 2″ of fiber are separated from the backing and the samples are cut into 1″ wide strips. Pull testing is carried out on an Instron 3366 at 50.8 mm/min and the average peel strength is measured for removal of 6″ of fiber from the backing using clamps gripping the fiber and the backing. The samples are also submitted to a 100° C. post cure treatment for 20 min. to determine if the laminating adhesive retains its latent character. Table 2 depicts the peel strength of the samples. As illustrated in Table 2, the post cure treated peel strength of Sample 2 and Sample 3 is greater than the initial peel strength, providing a ratio of peel strengths that is greater than 1.0.

TABLE 2
Peel Strength of the Samples

| | Peel |
|---|---|
| | Strength |
| | (N/mm) |
| Control (Initial) | 0.494 |
| Control (Post Cure) | 0.297 |
| Sample 2 (Initial) | 0.502 |
| Sample 2 (Post | 1.29 |
| Cure) | |
| Sample 3 (Initial) | 0.767 |
| Sample 4 (Post | 1.63 |
| Cure) | |

### Example 3

A tape is prepared for testing in conjunction with other samples when forming belt abrasives. To a 1′×1′ sample of the industrially laminated Mylar backing described in Example 2 (using 1 oz/yd² of Dorus ND4100 latent cure adhesive) is applied a 1-mil wet primer coat consisting of Dorus ND4100 diluted with water to 13% solids. The primer coat is oven dried at 100° C. for 3 min. Two applications of a 3-mil wet film of latent cure adhesive, Perm-Attach HC395 diluted to 21% solids, are applied and dried at ambient temperature. Tape samples (Sample 4) are cut at a 55° angle in ¾″ width.

Panels of R981 coated abrasive (Norton) 9.5″ long cut at 55 angles are skived on the backing via sandblasting a 0.375″ strip on the angled edges. The samples utilize a pre-treat adhesive on the skived area prior to fabricating the joint. The joints are pressed together using a head down pressure of 800 lb and a top platen temperature of 190° F. for 5 seconds. After joint fabrication, the panels are slit into ½″ wide belt samples. The belts are allowed to age 5 days before tensile testing. Four types of belt joint samples are prepared by the following approach:

1. A control sample is prepared by applying a solvent borne pre-treat coat to the skived area of abutting abrasive panels. The solvent borne pre-treat consists of 12 parts of 20% solids mixture of Sheldahl A0455 blended with a 0.3 parts of 6.5% ethyl acetate solution of Armeen DMCD catalyst (Akzo Nobel). One part of Desmodur L75 cross-linker is added to this adhesive before application. The adhesive is allowed to dry for 10 minutes and ¾″ Sheldahl blue tape is applied adhesive side down to the skived area with reinforcing fibers aligned in the belt direction.

2. A belt joint sample is prepared using ¾″ Sheldahl blue tape. The pre-treat used is Perm-Attach HC395 latent cure adhesive applied to the skived area with a paint roller and allowed to dry to tack free at room temperature. The joint is then prepared using the conditions described above.

3. A belt joint sample is prepared using the latent cure tape prepared as described above in relation to this example (Sample 4). The abrasive panels are pre-treated with solvent borne pre-treat and the belt joints are prepared using the conditions described above.

4. A belt joint sample is prepared using the latent cure tape (Sample 4) and the latent cure pre-treat. The belt joint is prepared using the conditions described above.

Joint samples are tensile tested using a cross-head speed of 2″/min on an Instron 4469 with a 1000 lb load cell. Peak break values are recorded for three replicates. Table 3 illustrates the peak break values. There are no adhesive failures in the test. In the latent cure tape samples the belt brakes above or below the joint, and the tape does not fail, indicating the joint is stronger than the belt.

TABLE 3
Peak Break for Joints

| | Peak | |
|---|---|---|
| | Break | |
| Sample | (lb) | Failure Mode |
| 1a. Control Sheldahl Blue, SB Pre-Treat | 148.6 | Tape failed at joint |
| 1b. Control Sheldahl Blue, SB Pre-Treat | 153.0 | Belt failed, tape intact |
| 1c. Control Sheldahl Blue, SB Pre-Treat | 153.9 | Belt failed, tape intact |
| 2a. Sheldahl Blue, Latent Pre-Treat | 155.2 | Belt failed, tape intact |
| 2b. Sheldahl Blue, Latent Pre-Treat | 149.5 | Belt failed, tape intact |
| 2c. Sheldahl Blue, Latent Pre-Treat | 139.5 | Tape failed at joint |
| 3a. Latent Tape, SB Pre-Treat | 154.4 | Belt failed, tape intact |
| 3b. Latent Tape, SB Pre-Treat | 128.8 | Belt failed, tape intact |
| 3c. Latent Tape, SB Pre-Treat | 157.5 | Belt failed, tape intact |
| 4a. Latent Tape, Latent Pre-Treat | 119.2 | Belt failed, tape intact |
| 4b. Latent Tape, Latent Pre-Treat | 139.2 | Belt failed, tape intact |
| 4c. Latent Tape, Latent Pre-Treat | 142.0 | Belt failed, tape intact |

In a first embodiment, a joint tape includes a film substrate, fibers disposed on a major surface of the film substrate, and a binder disposed over the major surface of the film substrate. The binder is derived from a latent cure urethane formulation including a surface deactivated isocyanate cross-linking agent and a polyol component.

In an example of the first embodiment, the polyol component includes urethane functionality. In another example, the polyol component includes a polyether polyol. In a further example, the polyol component includes a polyester polyol.

In an additional example of the first embodiment, the isocyanate cross-linking agent has an isocyanate functionality of at least 2. For example, the isocyanate functionality is at least 3. In a particular example, the isocyanate cross-linking agent includes triphenyl methane triisocyanate, tris(isocyanatophenyl)thiophosphate, polymethylene polyphenyl polyisocyanates, or any combination thereof.

In another example of the first embodiment, the film substrate includes a polyester film, a polyamide film, a polyaramid film, a polyimide film, a polyolefin, or any combination thereof. For example, the film substrate includes polyester film.

In a further example of the first embodiment, the fibers include polyester, polyether, polyolefin, polybenzimidazole (PBI), fibers or any combination thereof. For example, the fibers include polyester fibers. In another example, the fibers are arranged in parallel, such as arranged to be parallel to a machine direction.

In an additional example of the first embodiment, the surface deactivated isocyanate cross-linking agent includes a urea functional surface. In another example, the joint tape further includes an adhesive, the adhesive including a solvent-borne polyurethane adhesive. In an additional example, the joint tape further includes an adhesive, the adhesive including a latent cure urethane formulation including a surface deactivated isocyanate cross-linking agent and a polyol component.

In a second embodiment, a joint tape includes a film substrate, fibers disposed on a major surface of the film substrate, and an adhesive disposed over the major surface of the film substrate. The adhesive includes a latent cure urethane formulation including a surface deactivated isocyanate cross-linking agent and a polyol component.

In an example of the second embodiment, the polyol component includes urethane functionality. For example, the polyol component includes a polyether polyol. In another example, the polyol component includes a polyester polyol.

In a further example of the second embodiment, the isocyanate cross-linking agent has an isocyanate functionality of at least 2. For example, the isocyanate functionality is at least 3. In a particular example, the isocyanate cross-linking agent includes triphenyl methane triisocyanate, tris(isocyanatophenyl)thiophosphate, polymethylene polyphenyl polyisocyanates, or any combination thereof.

In another example of the second embodiment, the film substrate includes a polyester film, a polyamide film, a polyaramid film, a polyimide film, a polyolefin, or any combination thereof. For example, the film substrate includes polyester film.

In an additional example of the second embodiment, the fibers include polyester, polyether, polyolefin, polybenzimidazole (PBI), fibers or any combination thereof. For example, the fibers can include polyester fibers. In another example, the fibers are arranged in parallel, such as arranged to be parallel to a machine direction.

In a further example of the second embodiment, the surface deactivated isocyanate cross-linking agent includes a urea functional surface.

In a third embodiment, an abrasive belt includes a belt substrate. The belt substrate has first and second ends. The belt substrate is bent to define a joint between the first and second ends. The belt substrate forms an outer surface and an inner surface. The abrasive belt further includes an abrasive layer disposed on the outer surface of the belt substrate and a joint tape adhered to the inner surface at the joint and contacting the first and second ends. The joint tape includes a substrate, fibers disposed on a major surface of the substrate, and an adhesive disposed over the major surface of the substrate. The adhesive is derived from a latent cure urethane formulation including a surface deactivated solid isocyanate precursor and a polyol component.

In a fourth embodiment, a method of forming an abrasive belt includes preparing first and second ends of a belt substrate having an abrasive layer overlying a surface of the belt substrate. The method further includes bending the belt substrate to form a joint between the first and second ends. The abrasive layer forms an outer surface. The method also includes applying an adhesive at the joint and applying a joint tape over an inner surface of the belt substrate at the joint. The joint tape includes a substrate, fibers disposed on a major surface of the substrate, and an adhesive disposed over the major surface of the substrate. The adhesive includes a latent cure urethane formulation including a surface deactivated solid isocyanate precursor and a polyol component.

In an example of the fourth embodiment, the method further includes heating the joint tape. Heating can include heating to a temperature of at least 120° F.

In another example of the fourth embodiment, preparing the first and second ends includes splicing the first and second ends. In an additional example, preparing the first and second ends includes skiving the first and second ends. In a further example, preparing the first and second ends includes abrading a surface of the first and second ends. In another example, preparing the first and second ends includes cleaning the first and second ends.

In an additional example of the fourth embodiment, the adhesive includes a waterborne latent cure urethane formulation including the surface deactivated solid isocyanate precursor and the polyol component. In another example, the adhesive includes a solvent-borne polyurethane adhesive.

In a further example of the fourth embodiment, the joint tape further comprises a second adhesive, the second adhesive including a solvent-borne polyurethane adhesive.

In a fifth embodiment, a method of forming a joint tape includes dispensing a film and applying a binder to a major surface of the film. The binder includes a waterborne latent cure urethane formulation including the surface deactivated isocyanate cross-linking agent and the polyol component. The method further includes applying fibers to the major surface of the film and applying an adhesive to the major surface of the film.

In an example of the fifth embodiment, the method further includes curing the binder. Curing the binder can include heating the binder.

In another example of the fifth embodiment, applying the fibers includes applying the fibers in parallel.

In an additional example of the fifth embodiment, the adhesive includes a waterborne latent cure urethane formulation including the surface deactivated isocyanate cross-linking agent and the polyol component.

In a sixth embodiment, an abrasive belt includes a belt substrate. The belt substrate has first and second ends. The belt substrate is bent to define a joint between the first and second ends. The belt substrate forms an outer surface and an inner surface. The abrasive belt further includes an adhesive disposed in the joint and securing the first and second ends. The adhesive includes a latent cure urethane formulation including a surface deactivated solid isocyanate precursor and a polyol component.

In a seventh embodiment, a method of forming an abrasive belt includes dispensing a belt substrate having first and second ends, preparing the first and second ends, placing the first and second end in proximity to one another to define a joint between the first and second ends, and dispensing an adhesive in the joint and to secure the first and second ends. The adhesive includes a latent cure urethane formulation including a surface deactivated solid isocyanate precursor and a polyol component. The method further includes curing the adhesive.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A joint tape comprising:
a film substrate;
a binder disposed over a major surface of the film substrate, the binder derived from a latent cure urethane formulation including a surface deactivated isocyanate cross-linking agent and a polyol component; and
fibers disposed on the binder.

2. The joint tape of claim 1, wherein the polyol component includes urethane functionality.

3. The joint tape of claim 1, wherein the polyol component includes a polyether polyol.

4. The joint tape of claim 1, wherein the polyol component includes a polyester polyol.

5. The joint tape of claim 1, wherein the isocyanate cross-linking agent has an isocyanate functionality of at least 2.

6. The joint tape of claim 5, wherein the isocyanate functionality is at least 3.

7. The joint tape of claim 1, wherein the isocyanate cross-linking agent includes triphenyl methane triisocyanate, tris(isocyanatophenyl)thiophosphate, polymethylene polyphenyl polyisocyanates, or any combination thereof.

8. The joint tape of claim 1, wherein the film substrate includes a polyester film, a polyamide film, a polyaramid film, a polyimide film, a polyolefin, or any combination thereof.

9. The joint tape of claim 1, wherein the film substrate includes polyester film.

10. The joint tape of claim 1, wherein the fibers include polyester, polyether, polyolefin, polybenzimidazole (PBI), fibers or any combination thereof.

11. The joint tape of claim 10, wherein the fibers include polyester fibers.

12. The joint tape of claim 1, wherein the fibers are arranged in parallel.

13. The joint tape of claim 12, wherein the parallel fibers are arranged to be parallel to a machine direction.

14. The joint tape of claim 1, wherein the surface deactivated isocyanate cross-linking agent includes a urea functional surface.

15. The joint tape of claim 1, wherein the joint tape further comprises an adhesive, the adhesive including a solvent-borne polyurethane adhesive.

16. The joint tape of claim 1, wherein the joint tape further comprises an adhesive, the adhesive including a latent cure urethane formulation including a surface deactivated isocyanate cross-linking agent and a polyol component.

17. A joint tape comprising:
a film substrate;
fibers disposed on a major surface of the film substrate; and
an adhesive disposed over the fibers, the adhesive including a latent cure urethane formulation including a surface deactivated isocyanate cross-linking agent and a polyol component.

18.-41. (canceled)

42. A method of forming a joint tape, the method comprising:
dispensing a film;
applying a binder to a major surface of the film, the binder including a waterborne latent cure urethane formulation including the surface deactivated isocyanate cross-linking agent and the polyol component;
applying fibers to the major surface of the film; and
applying an adhesive to the major surface of the film.

43.-45. (canceled)

46. The method of claim 42, wherein the adhesive includes a waterborne latent cure urethane formulation including the surface deactivated isocyanate cross-linking agent and the polyol component.

47.-48. (canceled)
